(19) United States
(12) Patent Application Publication
(10) Pub. No.: US 2015/0077275 A1
(43) Pub. Date: Mar. 19, 2015

(54) Method and Apparatus for Automatic Location Check-In Control in a Vehicle

(71) Applicant: Ford Global Technologies, LLC, Dearborn, MI (US)

(72) Inventor: Elizabeth Halash, Dearborn, MI (US)

(73) Assignee: Ford Global Technologies, LLC, Dearborn, MI (US)

(21) Appl. No.: 14/031,257

(22) Filed: Sep. 19, 2013

(51) Int. Cl. G08G 1/123

(52) U.S. Cl. CPC G08G 1/123
USPC 340/993

(57) ABSTRACT

A system includes a processor configured to receive information relating to a vehicle state, designated to act as a trigger for a location check-in process. The processor is further configured to evaluate the state to determine if a trigger condition has been met and access a designated check-in site, when the trigger condition has been met. Also, the processor is configured to obtain user location information. The processor is additionally configured to provide the user location information to the check-in site for location updating.

### TECHNICAL FIELD

The illustrative embodiments generally relate to a method and apparatus for automatic location check-in control in a vehicle.

### BACKGROUND

In the interconnected world of modern life, people exist in a state of almost constant availability. Email, cellular phones and other devices and communication mediums allow a near-continuous availability of contact with a person. Further, advances in social networking have provided further opening up of user lives, whereby daily information relating to individual users may be obtained.

In accordance with this free-sharing spirit, many users like to notify others where they are at throughout the day. This could be done by posting a status update to a social networking site, by customizing an email response to incoming email, or through other methods. One such method is to “check in” at a location through use of an application providing “check in” functionality. Such an application will typically, at the request of the user, post information, relating to a user's current location, to a designated site.

For example, U.S. Application 2012/0233158 generally relates to a geo-social networking system that determines a user's current location, generate a list of places near the user's current location, rank the list of places based on distance, relevancy and a configurable rule set, and automatically checks in the user at the top ranked place.

And U.S. Pat. No. 8,369,867 generally relates to geographic location data being sent from a first device to a second device with a modified message to signal the presence of geographic location data associated with the message. The message can include (or attach) the geographic location data or file, or the message can include a link to a network-based resource which the second device can use to obtain the geographic location data. In some implementations, when a user of the first device views a location on a map display of the first device, a graphical user interface is presented to allow the user to select an option to share the geographic location with the second device. The second device receives geographic location data or a link from the first device which can trigger a map display on the second device showing the location of the first device and, optionally, the location of the second device.

### SUMMARY

In a first illustrative embodiment, a system includes a processor configured to receive information relating to a vehicle state, designated to act as a trigger for a location check-in process. The processor is further configured to evaluate the state to determine if a trigger condition has been met and access a designated check-in site, when the trigger condition has been met. Also, the processor is configured to obtain user location information. The processor is additionally configured to provide the user location information to the check-in site for location updating.

In a second illustrative embodiment, a computer-implemented method includes receiving information relating to a vehicle state, designated to act as a trigger for a location check-in process. The method also includes evaluating the state to determine if a trigger condition has been met. Further, the method includes accessing a designated check-in site, when the trigger condition has been met. The method also includes obtaining user location information and providing the user location information to the check-in site for location updating.

In a third illustrative embodiment, a non-transitory computer storage medium, stores instructions that, when executed by a processor, cause the processor to perform a method including receiving information relating to a vehicle state, designated to act as a trigger for a location check-in process. The method also includes evaluating the state to determine if a trigger condition has been met. Further, the method includes accessing a designated check-in site, when the trigger condition has been met. The method also includes obtaining user location information and providing the user location information to the check-in site for location updating.

### BRIEF DESCRIPTION OF THE DRAWINGS

FIG. 1 shows an illustrative vehicle computing system;

FIG. 2 shows an illustrative example of a location check-in process; and

FIG. 3 shows an illustrative example of a check-in restriction process.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

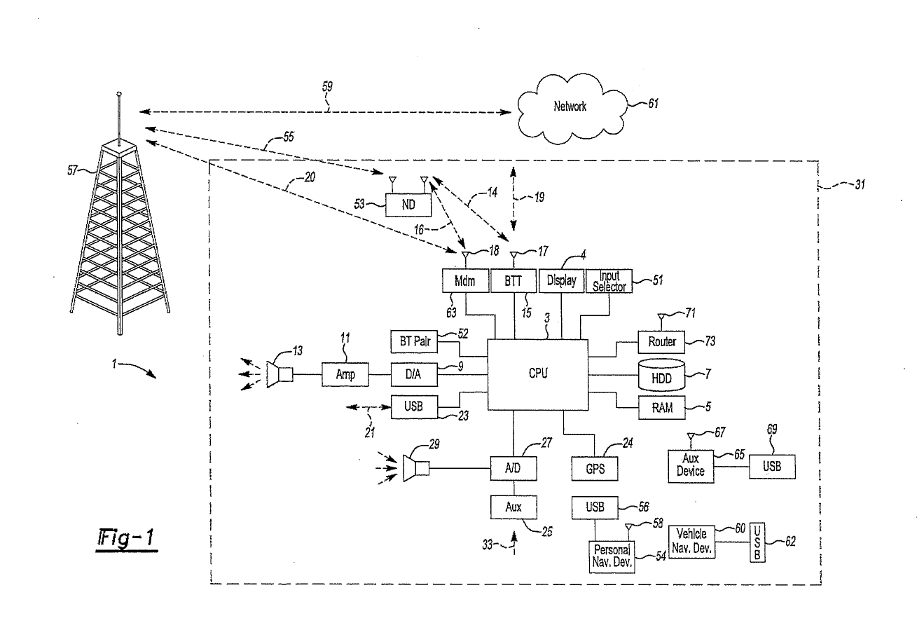

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a universal serial bus (USB) input 23, a global positioning system (GPS) input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a controller area network (CAN) bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as personal navigation device (PND) 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, personal digital assistant (PDA), or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the central processing unit (CPU) is instructed that the onboard BLUETOOTH transceiver will be paired with a BLUETOOTH transceiver in a nomadic device.

Data may be communicated between CPU 3 and network 61 utilizing, for example, a data-plan, data over voice, or dual-tone multi-frequency (DTMF) tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as infrared data association (IrDA)) and non-standardized consumer infrared (IR) protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of with Code Domian Multiple Access (CDMA), Time Domain Multiple Access (TDMA), Space-Domian Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (firewire), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

In a world of FACEBOOK, FOURSQUARE, TWITTER and other “personal information on demand” services, users have become accustomed to knowing where friends and family are at all times. Often, users will post updates showing a present location, so that people who may want to meet up know where they currently are. Such updates can be useful, too, when parents are attempting to keep track of children.

In the illustrative embodiments, the check-in functionality is associated with a vehicle. Since vehicles are often used to travel from location to location, a user exiting a vehicle will commonly be at a different location than the user was at when the user entered the vehicle. Through the illustrative embodiments, exemplary methods of providing location check-in upon such a location change are provided.

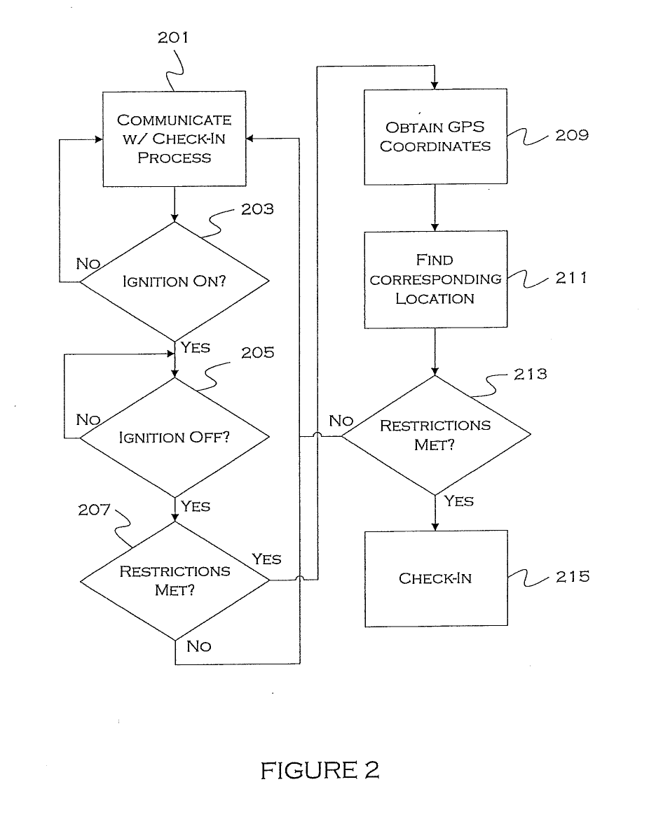

FIG. 2 shows an illustrative example of a location check-in process. In this illustrative example, a check-in process may be running on a computing system. The system could be a mobile system or based in a vehicle computer, or, in another example, could be remotely located in the cloud. In the illustrative example shown, a vehicle computing process communicates with the check-in process to convey various vehicle state information. For example, in this illustrative example, the process is concerned with whether or not the vehicle is in one of a number of ignition states.

In the illustrative example, the process receives ignition information from the vehicle, indicating that the ignition is in an on state 203. This will generally indicate that the vehicle is currently traveling, or is about to begin traveling. The system continues to receive ignition-on information until such a state no longer exists, at which point an ignition off state 205 is detected.

The ignition off state will be the trigger for a check-in update in this illustrative example, although other state changes could also be used, such as, but not limited to, driver leaving vehicle (seat detector, camera detector, etc.), door opening and closing, or other states that generally indicate that a journey has progressed from in-progress to completion.

Also, in this illustrative example, there can be a number of restrictions associated with a check-in. So as not to overly update a status, or if privacy is desired, the process may only update a user locale when the restrictions remain unmet. If there are restrictions, and they are met (i.e., check-in is permissible) 207, then the process will obtain current user GPS coordinates (e.g., vehicle coordinates, phone coordinates, etc).

In this illustrative example, there may be additional restrictions associated with various locations, that are different from the general check-in restrictions. For example, requirements to check-in a user may be met, but when a user is at a particular location (work, for example), location related restrictions may not be met, to avoid repeatedly updating a location when the user arrives at work every day.

The current GPS coordinates are compared to known locations to find a location that corresponds to the user's current location 211. This can be useful in both location updating and for the purpose of processing restrictions. For example, it may be determined that the user's coordinates correspond to a gas station. The user probably doesn't need to have people know that the stop at the gas station was made (since it is likely very temporary) and may have a restriction set that gas station locations are not to be updated.

In this case, the comparison would reveal the gas station location and, since the restrictions were not met 213, no update would be processed. On the other hand, if the restrictions were met, then the system would check-in with the user's location, posting a business, location name, coordinates, street intersection or address, etc.

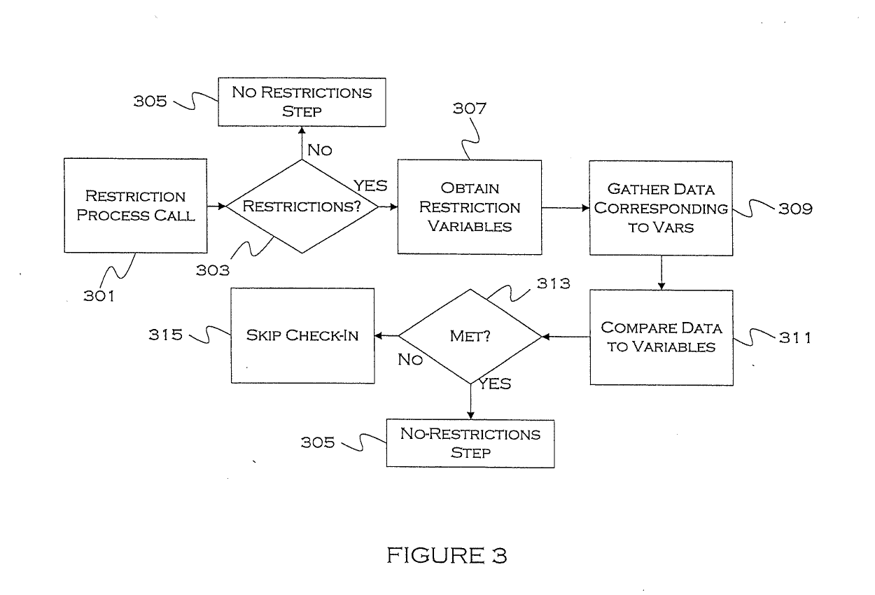

FIG. 3 shows an illustrative example of a check-in restriction process. This is a generalized process that can be applied to events when a restriction check is required. It is also an exemplary process, detailing just one possible manner in which restriction checks can be made.

In this illustrative example, the process receives a call to check whether or not any restrictions are present and/or met 301. If there are no restrictions, the process will return an indication that there are no restrictions or that all restrictions have been met 305. On the other hand, if restrictions exist, the process will obtain the various restriction settings, referred to as restriction variables, that correspond to the set restrictions.

Restrictions on check-in can come in a number of forms. They can be personally related (no check in for certain users), time of day related, day of week related, weather related, location related, etc. This list is by no means exhaustive. The process will receive the restriction parameters 307 and then gather data corresponding to the various parameters. For example, if a certain user had a no-check in policy for gas stations or work locations, M-F, from 9 AM to 5 PM, the process would gather a user ID, a location ID, a time of day and a day of week.

These data points would then be compared to the corresponding restriction parameters 311 to see if the requirements for check-in were met. They could be all required, or some could be required, and some could be parameter dependent. For example, the user may want no check-in ever for gas stations, so if that variable was met, the state of other restrictions could be irrelevant. On the other hand, the user could only want no work location check in between the specified hours and on the specified days, so if the work location was met, the time and day of week could be checked. But, for example, if the user went to a tertiary location on the specified time and/or day, the location may be posted.

Various restriction parameters may be set within the application, or set at a remote site and provided to the application. In another illustrative example, the process may alert the user to a proposed check-in, and require verification. User parameters may also be set within a vehicle, for example, and transferred to an application running on a phone. In still another embodiment, the phone may “learn” what check-ins are desired and not desired, based on user responses to check-in prompts, and gradually provide better focused automatic check-in.

For example, if the user always says “yes” to check-in when arriving home, then the process could eventually (or initially, if no learning was implemented) automatically check the user in at home, regardless of other variables. Or the automatic check-in may occur only if all other restrictions are met. Any number of variations on the theme can be implemented with reasonable skill in the art, and are within the contemplated scope of the invention.

In the FIG. 3 example, if all the requirements are met 313, the process will return a positive 317 to the calling process, allowing check-in to proceed. Otherwise, the check-in process may be skipped and the process can return to a waiting state.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
receive information relating to a vehicle state, designated to act as a trigger for a location check-in process;
evaluate the state to determine if a trigger condition has been met;
access a designated check-in site, when the trigger condition has been met;
obtain user location information; and
provide the user location information to the check-in site for location updating.

2. The system of claim 1, wherein the check-in site includes a social networking site.

3. The system of claim 1, wherein the vehicle state is an ignition state.

4. The system of claim 3, wherein the trigger condition is an ignition off state.

5. The system of claim 1, wherein the vehicle state is an occupant presence state.

6. The system of claim 5, wherein the trigger condition is an occupant not present state.

7. The system of claim 1, wherein the vehicle state is a door state.

8. The system of claim 7, wherein the trigger condition is a door opened state.

9. The system of claim 1, wherein the processor is further configured to:
access one or more restrictions relating to check-in permissibility;
determine if check-in is permissible based on the accessed restrictions; and
wherein the processor provides the user location information only if check-in is permissible based on the accessed restrictions.

10. A computer-implemented method comprising:
receiving information relating to a vehicle state, designated to act as a trigger for a location check-in process;
evaluating the state to determine if a trigger condition has been met;
accessing a designated check-in site, when the trigger condition has been met;
obtaining user location information; and
providing the user location information to the check-in site for location updating.

11. The method of claim 10, wherein the check-in site includes a social networking site.

12. The method of claim 10, wherein the vehicle state is an ignition state.

13. The method of claim 12, wherein the trigger condition is an ignition off state.

14. The method of claim 10, wherein the vehicle state is an occupant presence state.

15. The method of claim 14, wherein the trigger condition is an occupant not present state.

16. The method of claim 10, wherein the vehicle state is a door state.

17. The method of claim 16, wherein the trigger condition is a door opened state.

18. The method of claim 10, further comprising:
accessing one or more restrictions relating to check-in permissibility;
determining if check-in is permissible based on the accessed restrictions; and
wherein the providing the user location information only occurs if check-in is permissible based on the accessed restrictions.

19. A non-transitory computer storage medium, storing instructions that, when executed by a processor, cause the processor to perform a method comprising:
receiving information relating to a vehicle state, designated to act as a trigger for a location check-in process;
evaluating the state to determine if a trigger condition has been met;
accessing a designated check-in site, when the trigger condition has been met;
obtaining user location information; and
providing the user location information to the check-in site for location updating.

20. The storage medium of claim 19, wherein the method further comprises:
accessing one or more restrictions relating to check-in permissibility;
determining if check-in is permissible based on the accessed restrictions; and
wherein the providing the user location information only occurs if check-in is permissible based on the accessed restrictions.
